(19) United States
(12) Patent Application Publication
(10) Pub. No.: US 2001/0030263 A1
(43) Pub. Date: Oct. 18, 2001

(54) Launching device

(76) Inventor: Michael James Ciochetti, Mountain City, GA (US)

Correspondence Address: HARTMAN & HARTMAN, P.C., 552 EAST 700 NORTH, VALPARAISO, IN, 46383, US

(21) Appl. No.: 09/733,753

(22) Filed: Feb. 5, 2001

Related U.S. Application Data
(60) Provisional application No. 60/170,741, filed on Dec. 9, 1999.

(51) Int. Cl. F41J 9/08; A63H 27/08; B64C 31/06

(52) U.S. Cl. 244/154

(57) ABSTRACT

A launching device for releasing an article from a line, such as a string of a kite while the kite is aloft. The launching device includes a body with at least one blade and means for rotatably mounting the body on the kite string, so that the wind on which the kite is aloft rotates the body on the string. In this manner, the rotation of the body serves to release the article when the article encounters the body while sliding up the string toward the kite.

### CROSS REFERENCE TO RELATED APPLICATIONS

This application claims the benefit of U.S. Provisional Application No. 60/170,741, filed Dec. 9, 1999.

### BACKGROUND OF THE INVENTION

1. Field of the Invention

The present invention generally relates to a launcher for releasing an article above the ground, such as from the string of an aloft kite.

2. Description of the Prior Art

Various different devices have been proposed for launching or releasing toy parachutes, airplanes, etc., from the string of a kite while the kite is aloft. Some of these devices operate by attaching the toy to the string near the kite prior to flight, taking the kite aloft, and then releasing the toy by some action taken by the operator on the ground. Other release devices rely on the wind to push the toy up the string of an aloft kite until the toy encounters a release element attached to the string near the kite, which frees the toy from the string. In the latter type, the release element is often a stop that is impacted by a release mechanism on a sliding frame that holds the toy. An alternative release element is disclosed in U.S. Pat. No. 4,226,388 to Tilghman, and is configured to have a generally conical shape with tapered fins that extend radially from the string. Tilghman's release element is secured to the string of a kite with a knot or other suitable means, and therefore is not intended to move with respect to the string. A toy is suspended from a kite string with a hook or pulley that is forced off the string as the hook or pulley slides up and then off one of the tapered fins.

### BRIEF SUMMARY OF THE INVENTION

The present invention provides a launching device for releasing an article from a line with one elevated end, as is the case with the string of a kite while the kite is aloft. The launching device includes a body with at least one blade, and means for rotatably mounting the body on the line so that wind is able to rotate the body on the line. In this manner, the rotation of the body serves to release the article when the article encounters the body while sliding up the line toward its elevated end, e.g., along a string toward an aloft kite.

The objects and advantages of this invention will be better appreciated from the following detailed description.

### BRIEF DESCRIPTION OF THE DRAWINGS

FIG. 1 shows a launching device and launch vehicles on an aloft kite in accordance with this invention.

FIGS. 2 and 3 show a wind turbine and axle, respectively, of the launching device of FIG. 1.

FIG. 4 shows the wind turbine and axle of FIGS. 2 and 3 assembled and secured to a kite string.

FIG. 5 shows one of the launch vehicles of FIG. 1.

### DETAILED DESCRIPTION OF THE INVENTION

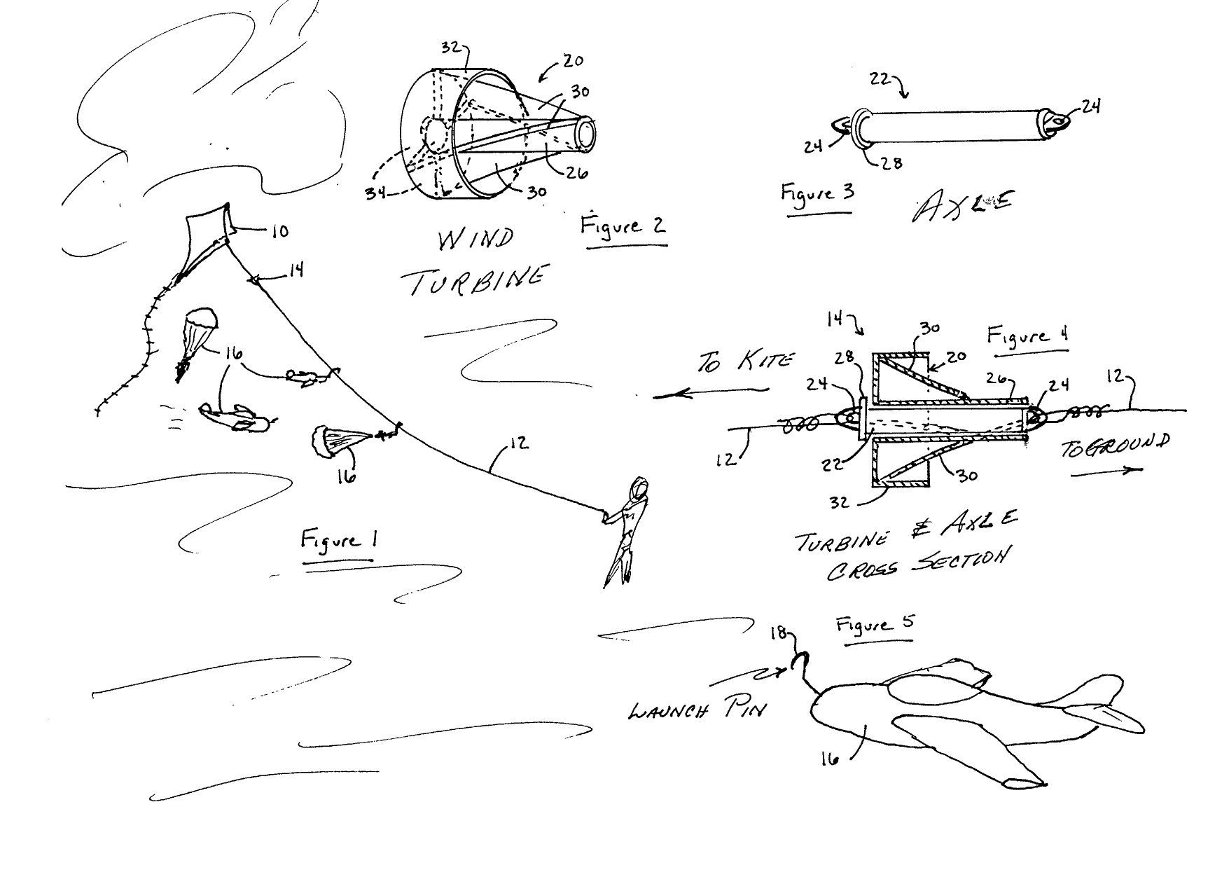

FIG. 1 represents a kite 10 being flown by a person with a string 12 attached to the kite 10 in a typical manner. While the kite 10 is shown as having a conventional diamond shape, the present invention is suitable for use with essentially any type of kite. A launching device 14 in accordance with the present invention is shown as being mounted to the kite string 12 near the kite 10, though the launching device 14 could be located anywhere along the length of the string 12. Also shown in FIG. 1 are several launch vehicles 16, two of which are a parachute and airplane already released from the string 12 by the launching device 14, while a second parachute and a second airplane are still secured to the string 12. As shown in FIG. 5, the launch vehicles 16 may be secured to the string 12 with a pin or hook 18, though it is foreseeable that other types of securing devices could be used as long as the vehicles 16 can be released with the launching device 14 in the manner described below. The hooks 18 serve to secure their respective vehicles 16 to the string 12 as the vehicles 16 are being pushed by the wind upward along the string 12 toward the kite 10. A parachute or other type of sail can be used to assist the airplanes up the string 12, as is known in the art. Alternatively, the airplanes could be pulled or pushed up the string 12 by other means.

FIGS. 2 through 4 show the launching device 14 and its components in greater detail. The device 14 includes a wind turbine 20 rotatably mounted on an axle 22. Suitable materials for the turbine 20 and axle 22 include plastic materials chosen for their ability to minimize the sliding friction between the turbine 20 and axle 22. The opposite ends of the axle 22 are equipped with eyelets 24 with which the axle 22 can be secured to the string 12, as shown in FIG. 4. Other devices for securing the axle 22 to the string 12 are also foreseeable. The axle 22 has a generally cylindrical shape and is received in an axial passage within a tubular portion 26 of the turbine 20, as shown in FIG. 4. The turbine 20 abuts against a radial shoulder 28 on the axle 22, such that the turbine 20 is free to rotate on the axle 22 but is prevented from being forced upward off the axle 22 by the wind. The turbine 20 further includes tapered blades 30 that extend radially outward from the tubular portion 26, and an annular portion 32 that circumscribes the wider portion of each blade 30. As seen in FIGS. 2 and 4, the blades 30 project axially outward from between the tubular portion 26 and the annular portion 32 of the turbine 20, extending essentially along the entire length of the tubular portion 26. The wider portions of the blades 30 interconnect the tubular and annular portions 26 and 32, defining vents 34 through which the wind driving the turbine 20 is able to flow through the turbine 20 by flowing over and around the blades 30 and between the tubular and annular portions 26 and 32. As shown, the blades 30 are preferably helical around the tubular portion 26 so that wind flowing the turbine 20 will cause the turbine 20 to rotate on the axle 22 at some suitable speed.

According to the invention, the blades 30 of the launching device 14 serve to release the vehicles 16 from the string 12 body as a result of the turbine 20 being rotated on the axle 22, such that one of the blades 30 will intercept and dislodge the hook 18 from the string 12. The force necessary to dislodge the hook 18 from the string 12 will depend in part on the weight of the vehicle 16 and the drag force created by the wind resistance of the vehicle 16. Those skilled in the art will appreciate that, in addition to the weight of the turbine 20, the contour of the blades 30 can be selected to achieve a rotational velocity for the turbine 20 that will be adequate to dislodge the hook 18 from the string 12.

While the invention has been described in terms of a preferred embodiment, it is apparent that other forms could be adopted by one skilled in the art. For example, the launching device could be used to launch vehicles from a string, rope or wire connected to essentially any elevated object, including a pole, balloon or feature on a building. In addition, appropriate materials could be substituted for those noted, and the appearance of the launching device 14 and its components could differ from that shown in the Figures. Accordingly, the scope of the invention is to be limited only by the following claims.

1. A launching device for releasing an article supported on a line, the launching device comprising:
a body having at least one blade and means for releasing the article from the line; and
means for rotatably mounting the body on the line so that wind flowing past the at least one blade is able to cause the body to rotate on the line;
wherein the releasing means of the body is effective to dislodge the article from the line when the body rotates on the mounting means.

2. A launching device according to claim 1, wherein the body comprises a tubular portion from which multiple blades extend radially outward.

3. A launching device according to claim 2, wherein the body further comprises an annular portion that circumscribes at least portions of the tubular portion and the multiple blades of the body, the multiple blades projecting axially outward from the annular portion.

4. A launching device according to claim 3, wherein the body further comprises vents through which the wind is able to exit the body after flowing around the blades and between the annular and tubular portions of the body.

5. A launching device according to claim 1, wherein the body comprises a tubular portion having an axial passage, and wherein the mounting means comprises a cylindrically-shaped axle slidably received within the axial passage of the tubular portion.

6. A launching device according to claim 5, wherein the axle has oppositely-disposed ends that are secured to the line.

7. A launching device according to claim 1, wherein the at least one blade is the releasing means of the body.

8. A launching system mountable to a string of a kite, the launching system comprising:
an article having means for releasably securing the article to the string of the kite;
an axle having means for securing the axle to the string of the kite;
a wind turbine mountable on the axle so that the wind turbine freely rotates on the axle, the wind turbine comprising at least one blade capable of causing the article securing means to release the article from the string of the kite as the wind turbine rotates.

9. A launching system according to claim 8, wherein the wind turbine comprises a tubular portion from which multiple blades extend radially outward.

10. A launching system according to claim 9, wherein the wind turbine further comprises an annular portion that circumscribes at least portions of the tubular portion and the multiple blades of the wind turbine, the multiple blades being between the annular and tubular portions.

11. A launching system according to claim 10, wherein the wind turbine further comprises vents through which the wind is able to exit the wind turbine after flowing around the blades and between the annular and tubular portions of the wind turbine.

12. A launching system according to claim 8, wherein the wind turbine comprises a tubular portion having an axial passage in which the axle is slidably receivable.

13. A launching system according to claim 8, wherein the axle has oppositely-disposed ends at which the axle securing means are located.

14. A launching system according to claim 8, wherein the axle has a radial shoulder against which the wind turbine abuts for retaining the wind turbine on the axle.

15. A launching system according to claim 8, wherein the article securing means is a hook.

16. A launching system comprising:
a kite;
a string attached to the kite;
an article having means for releasably securing the article to the string of the kite and means for enabling wind to push the article up the string toward the kite when the kite is aloft;
an axle having means for securing the axle to the string of the kite;
a wind turbine mounted on the axle so that the wind turbine freely rotates on the axle, the wind turbine comprising a tubular portion in which the axle is received, multiple blades extending radially outward from the tubular portion, and an annular portion that circumscribes portions of the blades such that the blades project axially outward from the annular portion.

17. A launching system according to claim 16, wherein the wind turbine further comprises vents through which the wind is able to exit the wind turbine after flowing around the blades and between the annular and tubular portions of the wind turbine.

18. A launching system according to claim 16, wherein the axle has oppositely-disposed ends at which the axle securing means are located.

19. A launching system according to claim 16, wherein the axle has a radial shoulder against which the tubular portion of the wind turbine abuts for retaining the wind turbine on the axle.

20. A launching system according to claim 16, wherein the article securing means is a hook.
